(19) United States
(12) Patent Application Publication
(10) Pub. No.: US 2023/0406350 A1
(43) Pub. Date: Dec. 21, 2023

(54) APPARATUS AND METHOD FOR DECISION-MAKING OF AGENT USING EPISODIC FUTURE THINKING MECHANISM

(71) Applicant: FOUNDATION OF SOONGSIL UNIVERSITY-INDUSTRY COOPERATION, Seoul (KR)

(72) Inventors: Minhae KWON, Seoul (KR); Dongsu LEE, Seoul (KR)

(73) Assignee: FOUNDATION OF SOONGSIL UNIVERSITY-INDUSTRY COOPERATION, Seoul (KR)

(21) Appl. No.: 17/959,550

(22) Filed: Oct. 4, 2022

(30) Foreign Application Priority Data
Jun. 21, 2022 (KR) 10-2022-0075303

(51) Int. Cl. B60W 60/00; B60W 40/04; G06N 5/04; G06N 3/08; G06F 17/11

(52) U.S. Cl. CPC B60W 60/0011; B60W 40/04; G06N 5/04; G06N 3/08; G06F 17/11; B60W 2554/4045; B60W 2554/4046

(57) ABSTRACT

The present disclosure relates to an apparatus and a method for deciding a behavior of an agent, and more particularly, to an apparatus and a method for deciding a behavior of a single agent using an episodic future thinking mechanism. The decision-making method according to an exemplary embodiment of the present disclosure includes collecting observation information and behavior information of a surrounding agent, by a first information collecting unit; inferring a character coefficient of a surrounding agent using data of the first information collecting unit, by a character inferring unit, collecting observation information of a main agent and the surrounding agent at a first time point, by a second information collecting unit; predicting a behavior of the surrounding agent based on the observation information and the character coefficient of the surrounding agent, by a behavior predicting unit, inferring expected observation information of the environment state and the surrounding agent at a second time point corresponding to the behavior prediction result of the surrounding agent, by a state inferring unit; and deciding a behavior of the main agent at the first time point based on the expected observation information of the environment state and the surrounding agent at a second time point, by a decision-making unit.

### CROSS-REFERENCE TO RELATED APPLICATIONS

This application claims the priority of Korean Patent Application No. 10-2022-0075303 filed on Jun. 21, 2022, in the Korean Intellectual Property Office, the disclosure of which is incorporated herein by reference.

### BACKGROUND

### Field

The present disclosure relates to an apparatus and a method for decision-making of an agent, and more particularly, to an apparatus and a method for decision-making of a single agent using an episodic future thinking mechanism.

### Description of the Related Art

In accordance with the success of a deep neural network which is one type of artificial neural networks, studies on various machine learning methods are being accelerated in recent years. Among them, reinforcement learning which is one type of machine learning inspired by human learning methods has been highlighted as a potential application in various fields.

The reinforcement learning is a field of machine learning and refers to a learning method in which an agent defined in a specific environment recognizes a current state to select a behavior to maximize the reward among selectable behaviors. Further, a deep reinforcement learning method to which a deep neural network is applied is based on the interaction of a learning model which performs the learning and the environment. Accordingly, the learning model is trained so as to perform a behavior to acquire an optimal reward in a specific environment by reinforcement learning.

In the meantime, the reinforcement learning technique of the related art determines a behavior of a main agent based on environment information or observation information at a single time point. This may not be a problem if there is no interacting surrounding agent nearby. However, in a multi-agent situation, if a future behavior to be generated by the behavior of the surrounding agents is not considered, there may be a problem in the safety.

Accordingly, in order to determine a behavior of deep reinforcement learning, there is a necessity for a technology for performing reinforcement learning with a high reward by considering the behavioral prediction of a surrounding agent and future state information of the surrounding agent.

### SUMMARY

An object of the present disclosure is to provide a decision-making apparatus and method which determine a behavior of a main agent with a high reward by considering future environment information by predicting a behavior of a surrounding agent.

In addition, another object of the present disclosure is to provide a decision-making apparatus and method which accurately infer a feature of the surrounding agent using the maximum likelihood method and the gradient descent method.

The objects of the present disclosure are not limited to the above-mentioned objects and other objects and advantages of the present disclosure which have not been mentioned above may be understood by the following description and become more apparent from exemplary embodiments of the present disclosure. Further, it is understood that the objects and advantages of the present disclosure may be embodied by the means and a combination thereof in the claims. According to an aspect of the present disclosure, a

decision-making method includes: collecting observation information and behavior information of a surrounding agent, by a first information collecting unit; determining a character coefficient of the surrounding agent using the maximum likelihood method based on the observation information of the surrounding agent, by a character inferring unit; collecting observation information of a main agent and the surrounding agent at a first time point, by a second information collecting unit; predicting a behavior of the surrounding agent based on the observation information of the main agent and the surrounding agent at the first time point and the character coefficient of the surrounding agent, by a behavior predicting unit; inferring expected observation information of the main agent including the surrounding agent and the environment at a second time point corresponding to the behavior prediction result of the surrounding agent, by a state inferring unit; and deciding a behavior of the main agent at the first time point based on the expected observation information of the main agent including a surrounding agent and an environment at a second time point, by a decision-making unit.

In an exemplary embodiment of the present disclosure, the determining of a character coefficient of the surrounding agent includes: randomly initializing an estimated character coefficient of the surrounding agent; sampling a behavior of the surrounding agent using the estimated character coefficient, the observation information, and a multi-character reinforcement learning model; and determining the character coefficient of the surrounding agent by comparing the sampled behavior and the behavior information.

In an exemplary embodiment of the present disclosure, the estimated character coefficient of the surrounding agent is updated by the following Equation 1.

$$\\ \begin{matrix}{\hat{c}}_{k + 1} = arg {max}_{c} {\sum }_{t = 1}^{T} [ - ( \frac{1}{2} ln 2 π {σ}_{π}^{2} + \frac{{a}_{acc , t} - {a}_{acc , t}^{*}}{2 π {σ}_{π}^{2}} ) + ( {a}_{lc , t} - {a}_{lc , t}^{*} ) ] & [ Equation 1 ]\end{matrix}$$

Here, ĉₖ₊₁ is an updated estimated character coefficient of the surrounding agent, a_{acc,t} and a_{lc,t} are sampled behaviors of the surrounding agent, and a_{acc,t}* and a_{lc,t}* are (actual) behavior information of the surrounding agent, respectively.

In an exemplary embodiment of the present disclosure, in the predicting of a behavior of the surrounding agent, the behavior of the surrounding agent is predicted using observation information of the surrounding agent excluding the observation information of the main agent, among observation information collected by the second information collecting unit.

According to an aspect of the present disclosure, a decision-making apparatus includes one or more processors which execute an instruction. The one or more processors perform: collecting observation information and behavior information of a surrounding agent, by a first information collecting unit; determining a character coefficient of the surrounding agent using the maximum likelihood method based on the observation information of the surrounding agent, by a character inferring unit; collecting observation information of a main agent and the surrounding agent at a first time point, by a second information collecting unit; predicting a behavior of the surrounding agent based on the observation information of the main agent and the surrounding agent at the first time point and the character coefficient of the surrounding agent, by a behavior predicting unit; inferring expected observation information of the main agent including the surrounding agent and the environment at a second time point corresponding to the behavior prediction result of the surrounding agent, by a state inferring unit; and deciding a behavior of the main agent at the first time point based on the expected observation information of the main agent including a surrounding agent and an environment at a second time point, by a behavior determining unit.

In an exemplary embodiment of the present disclosure, the character inferring unit randomly initializes an estimated character coefficient of the surrounding agent, samples a behavior of the surrounding agent using the estimated character coefficient, the observation information, and a multi-character reinforcement learning model, and determines the character coefficient of the surrounding agent by comparing the sampled behavior and the behavior information. In an exemplary embodiment of the present disclosure, the

estimated character coefficient of the surrounding agent is updated by the following Equation 1.

$$\\ \begin{matrix}{\hat{c}}_{k + 1} = arg {max}_{c} {\sum }_{t = 1}^{T} [ - ( \frac{1}{2} ln 2 π {σ}_{π}^{2} + \frac{{a}_{acc , t} - {a}_{acc , t}^{*}}{2 π {σ}_{π}^{2}} ) + ( {a}_{lc , t} - {a}_{lc , t}^{*} ) ] & [ Equation 1 ]\end{matrix}$$

Here, ĉₖ₊₁ is an updated estimated character coefficient of the surrounding agent, a_{acc,t} and a_{lc,t} are sampled behaviors of the surrounding agent, and a_{acc,t}* and a_{lc,t}* and are (actual) behavior information of the surrounding agent, respectively.

In an exemplary embodiment of the present disclosure, the behavior predicting unit predicts the behavior of the surrounding agent using observation information of the surrounding agent excluding the observation information of the main agent, among observation information collected by the second information collecting unit.

According to the present disclosure, the decision-making apparatus and method may determine a behavior of a main agent with a high reward by considering future environment information by predicting a behavior of a surrounding agent.

Further, according to the present disclosure, the decision-making apparatus and method may accurately infer a feature of the surrounding agent using the maximum likelihood method.

### BRIEF DESCRIPTION OF THE DRAWINGS

The above and other aspects, features, and other advantages of the present disclosure will be more clearly understood from the following detailed description taken in conjunction with the accompanying drawings, in which:

FIG. 1 is a block diagram of a decision-making apparatus according to an exemplary embodiment of the present disclosure;

FIG. 2 is an operation flowchart of a decision-making apparatus according to an exemplary embodiment of the present disclosure;

FIG. 3 is a flowchart illustrating an operation of a behavior predicting unit in an exemplary embodiment of the present disclosure;

FIG. 4 is a view illustrating a process of inferring a future state of a surrounding agent in an exemplary embodiment of the present disclosure;

FIG. 5 is a graph illustrating a performance result of a decision-making apparatus according to an exemplary embodiment of the present disclosure; and

FIG. 6 is a flowchart of a decision-making method according to an exemplary embodiment of the present disclosure.

### DETAILED DESCRIPTION OF THE EMBODIMENT

Those skilled in the art may make various modifications to the present disclosure and the present disclosure may have various embodiments thereof, and thus specific embodiments will be illustrated in the drawings and described in detail in the detailed description. However, this does not limit the present disclosure within specific exemplary embodiments, and it should be understood that the present disclosure covers all the modifications, equivalents, and replacements within the spirit and technical scope of the present disclosure. In the description of respective drawings, similar reference numerals designate similar elements.

Terms such as first, second, A, or B may be used to describe various components but the components are not limited by the above terms. The above terms are used only to distinguish one component from the other component. For example, without departing from the scope of the present disclosure, a first component may be referred to as a second component, and similarly, a second component may be referred to as a first component. A term of and/or includes a combination of a plurality of related elements or any one of the plurality of related elements.

It should be understood that, when it is described that an element is “coupled” or “connected” to another element, the element may be directly coupled or directly connected to the other element or coupled or connected to the other element through a third element . In contrast, when it is described that an element is “directly coupled” or “directly connected” to another element, it should be understood that no element is not present therebetween.

Terms used in the present application are used only to describe a specific exemplary embodiment but are not intended to limit the present disclosure. A singular form may include a plural form if there is no clearly opposite meaning in the context. In the present disclosure, it should be understood that the terminology “include” or “have” indicates that a feature, a number, a step, an operation, a component, apart, or the combination thereof described in the specification is present, but do not exclude a possibility of presence or addition of one or more other features, numbers, steps, operations, components, parts, or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of related art, and shall not be construed in ideal or excessively formal meanings unless they are clearly defined in the present application.

In the present disclosure, a main agent refers to an agent which becomes a target for deciding a behavior and a surrounding agent refers to the remaining agents excluding the main agent, among multiple agents and there may be a plurality of surrounding agents.

Hereinafter, an exemplary embodiment of the present disclosure will be described in detail with reference to the accompanying drawings.

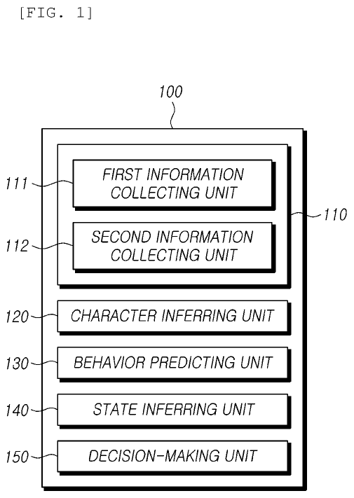

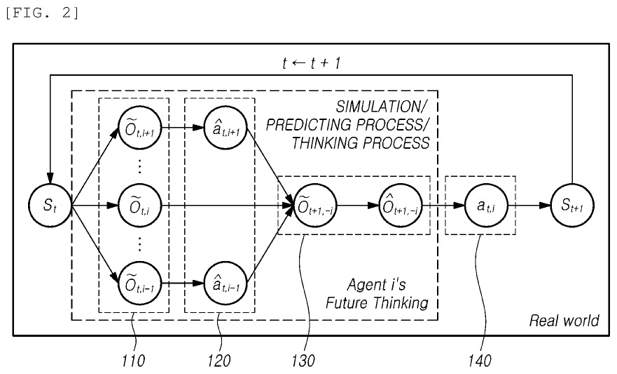

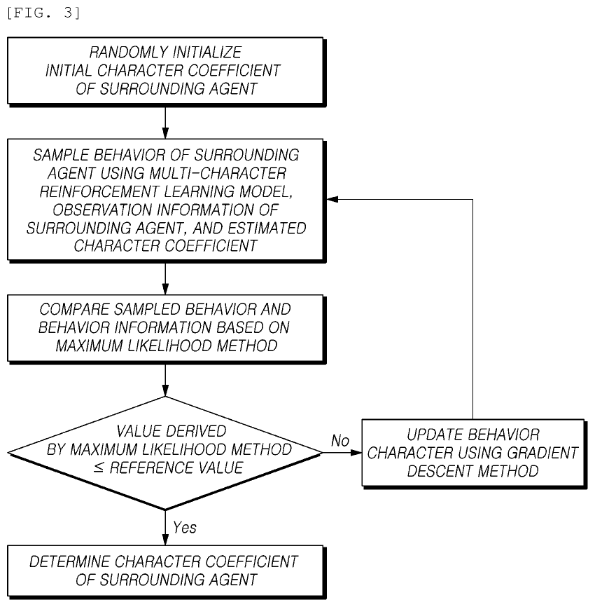

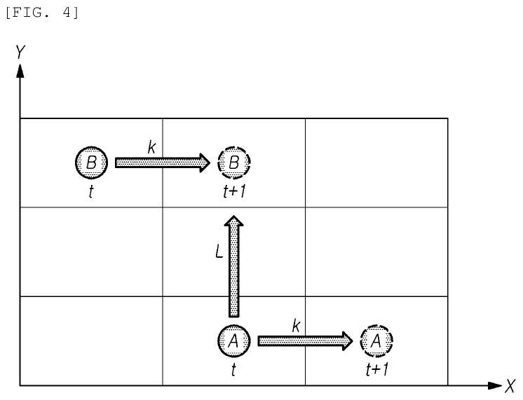

FIG. 1 is a block diagram of a decision-making apparatus according to an exemplary embodiment of the present disclosure, FIG. 2 is an operation flowchart of a decision-making apparatus according to an exemplary embodiment of the present disclosure, FIG. 3 is a flowchart illustrating an operation of a behavior predicting unit in an exemplary embodiment of the present disclosure, and FIG. 4 is a view illustrating a process of inferring a future state of a surrounding agent in an exemplary embodiment of the present disclosure.

Referring to FIGS. 1 and 2, a decision-making apparatus 100 includes an information collecting unit 110, a character inferring unit 120, a behavior predicting unit 130, a state inferring unit 140, and a decision-making unit 150.

The information collecting unit 110 includes a first information collecting unit 111 and a second information collecting unit 112 and the first information collecting unit 111 collects observation information and behavior information of a surrounding agent at multiple time points, rather than a specific time point. Observation information refers to data obtained by observing the surrounding agent and will be used as a learning data set of the multi-character reinforcement learning model later.

Further, behavior information is information including a moving speed and a moving direction of the surrounding agent and refers to information about an actual behavior of the surrounding agent.

The observation information may be shared and collected by communication with a main agent or a surrounding agent and the behavior information may be collected by observing the surrounding agent by the main agent.

The second information collecting unit 112 collects observation information of the main agent and observation information of the surrounding agent at the first time point, that is, the observation information of all the multi-agents. The agent is not limited to a specific object, but may include all objects which are capable of making a decision or deciding a behavior, such as humans and vehicles.

The observation information of the main agent and the surrounding agent at the first time point collected by the second information collecting unit 112 is used to predict a behavior of the surrounding agent as an input of the behavior predicting unit 130 together with a character coefficient of the surrounding agent.

The character inferring unit 120 determines the character coefficient of the surrounding agent using the maximum likelihood method based on the observation information of the surrounding agent collected by the first information collecting unit 111.

The character coefficient of the surrounding agent is a weight that is assigned to each behavior character of the surrounding agent and may be calculated by a multi-character reinforcement learning model which is trained in advance. That is, the character inferring unit 120 may calculate the character coefficient of the surrounding agent by the multi-character reinforcement learning model with the observation information of the surrounding agent collected by the first information collecting unit 111 as an input.

Specifically, a process of calculating a character coefficient of the surrounding agent will be described. As illustrated in FIG. 3, the character inferring unit 120 randomly initializes an estimated character coefficient of the surrounding agent, samples the behavior of the surrounding agent using the multi-character reinforcement learning model, the observation information of the surrounding agent, and the estimated character coefficient, and compares a behavior sampled based on the maximum likelihood method and an actual behavior (that is, the behavior information of the surrounding agent) to determine the number of characters of the surrounding agent. Specifically, when the estimated character coefficient (a value derived by the maximum likelihood method) according to the difference between the sampled behavior and the actual behavior of the surrounding agent is equal to or lower than a predetermined reference value, the character inferring unit 120 may determine the corresponding estimated character coefficient as a character coefficient of the surrounding agent.

In contrast, when the estimated character coefficient according to the difference between the sampled behavior and the actual behavior of the surrounding agent exceeds the predetermined reference value, the character inferring unit 120 repeats a process of updating a new estimated character coefficient by the feedback of the actual behavior character of the surrounding agent.

The estimated character coefficient of the surrounding agent using the maximum likelihood method may be updated by the following Equation 1.

$$\\ \begin{matrix}{\hat{c}}_{k + 1} = arg {max}_{c} {\sum }_{t = 1}^{T} [ - ( \frac{1}{2} ln 2 π {σ}_{π}^{2} + \frac{{a}_{acc , t} - {a}_{acc , t}^{*}}{2 π {σ}_{π}^{2}} ) + ( {a}_{lc , t} - {a}_{lc , t}^{*} ) ] & [ Equation 1 ]\end{matrix}$$

Here, ĉₖ₊₁ is an updated estimated character coefficient of the surrounding agent, a_{acc,t} and a_{lc,t} are sampled behaviors of the surrounding agent, and a_{acc,t}* and a_{lc,t}* are (actual) behavior information of the surrounding agent, respectively. In the meantime, according to the exemplary embodiment, as the method for updating the estimated character coefficient, a gradient descent method algorithm may be used.

According to another exemplary embodiment, when the estimated character coefficient according to the difference between the sampled behavior and the actual behavior of the surrounding agent converges to a specific value, the character inferring unit 120 may determine the estimated character coefficient as a character coefficient of the surrounding agent.

Similarly, when the estimated character coefficient according to the difference between the sampled behavior and the actual behavior of the surrounding agent does not converge to a specific value, the character inferring unit 120 repeats a process of updating a new estimated character coefficient by the feedback of the actual behavior character of the surrounding agent.

As described above, the character inferring unit 120 may determine an optimal character coefficient by repeatedly updating the estimated character coefficient using the maximum likelihood method and the gradient descent method.

The behavior predicting unit 130 predicts the behavior of the surrounding agent based on the observation information and the calculated character coefficient of the surrounding agent.

At this time, the behavior predicting unit 130 may predict the behavior of the surrounding agent using only the observation information of the surrounding agent excluding the observation information of the main agent. For example, when the agent is an autonomous vehicle, the behavior predicting unit 130 may predict the behavior (a speed or a direction) of a surrounding vehicle using the observation information of the surrounding vehicle, rather than the observation information of the autonomous vehicle. Accordingly, the decision-making unit to be described below may determine a subsequent behavior of the autonomous vehicle so as to prevent a minor collision with the surrounding vehicle.

The state inferring unit 140 infers expected observation information of the main agent including the surrounding agent and the environment at a second time point according to the behavior prediction result of the surrounding agent. The second time point is different from the first time point and is a time point after a predetermined time has elapsed from the first time point and the expected observation information refers to observation information at the second time point which is estimated by the main agent together with the surrounding agent and the environment.

For example, referring to FIG. 4, when the behavior prediction unit 130 predicts a behavior of the surrounding agent B that moves to the X direction at a speed of k at the first time point t, the state inferring unit 140 may infer the environment state and expected observation information at the second time point t+1 for the movement of the surrounding agent B. At this time, since the purpose is to predict the future for selecting of the behavior of the main agent A at the first time point t, the behavior predicting unit 130 does not consider the behavior of the main agent A to infer the environment state and the expected observation information at the second time point.

In the meantime, when the state of the surrounding agent at the second time point is inferred using the behavior prediction result, the state inferring unit 140 may infer the environment state and expected observation information of the surrounding agent at the second time point based on classical physics.

The decision-making unit 150 determines a behavior of the main agent at the first time point based on the environment state and the expected observation information of the surrounding agent at the second time point. Referring to FIG. 4 again, when the main agent A moves in a Y direction at a speed L, the main agent is located in the same coordinate as the surrounding agent B at the second time point so that the collision may occur. Accordingly, in order to avoid the collision of the main agent and the surrounding agent, the decision-making unit 150 determines a behavior of the main agent A to move to the X direction at the first time point t or determine a behavior of the main agent A to move at the speed k in the Y direction at the first time point t.

As described above, the decision-making unit 150 determines the behavior of the main agent at the first time point according to expected observation information of the main agent including the surrounding agent and the environment at the second time point corresponding to the behavior prediction result of the surrounding agent so that an optimal behavior may be determined.

An overall flow of the decision-making apparatus in FIG. 2 will be described again. The decision-making apparatus 100 predicts a behavior ãₜ to be performed by the surrounding agent based on observation information [symbol] (collected by observation/inference/communication) for surrounding agents i+1, i−1, . . . and a main agent i in a state Sₜ at the first time point t. At this time, the observation information of the main agent i is not considered, and the decision-making apparatus 100 collects expected observation information [symbol] of the main agent including a surrounding agent and the environment at the second time point t+1 with respect to the predicted behavior and determines a behavior a_{t,i} of the main agent at the first time point.

That is, the behavior of the main agent at the first time point is determined based on the expected observation information at the second time point, and a final environment state Sₜ₊₁ at the second time point is determined according to the behaviors of the main agent and the surrounding agents.

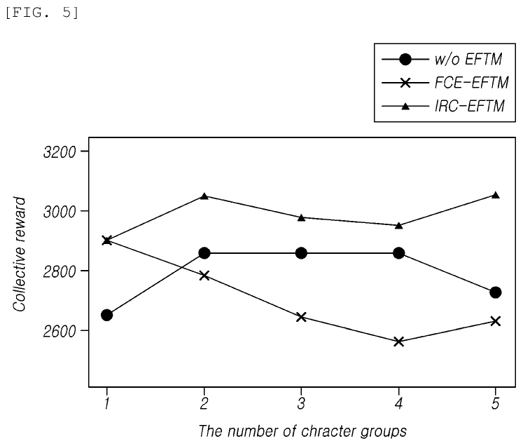

FIG. 5 is a graph illustrating a performance result of a decision-making apparatus according to an embodiment of the present disclosure.

Referring to FIG. 5, a horizontal axis of the graph is the number of groups classified according to a character of the multi-agent, and a vertical axis refers to the average of the reward of the entire agents. In the horizontal axis, the more diverse the characters of the multi-agent, the larger the number of groups.

The IRC-EFTM which is the decision-making apparatus 100 of the present disclosure may perform both episodic future thinking mechanism (EFTM) which predicts a future behavior the inference (inverse rational control: IRC) which determines the behavior of the main agent by reflecting a behavior character of the surrounding agent. FCE-EFTM may perform inference (FCE) which does not consider the EFTM and the behavior character of the surrounding agent, and W/O EFTM which is general reinforcement learning does not perform both the episodic future thinking mechanism and the inference.

As described above, it may be confirmed that the IRC-EFTM has a higher compensation value than that of the FCE-EFTM and W/O EFTM which are the related art in all groups and takes a gain in view of the entire groups.

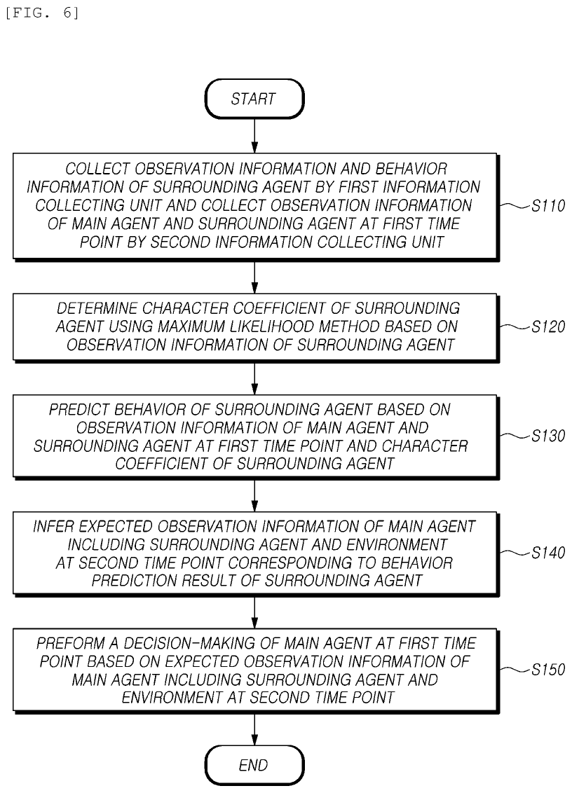

FIG. 6 is a flowchart of a decision-making method according to an exemplary embodiment of the present disclosure.

First, the decision-making apparatus collects observation information and behavior information of the surrounding agent by the first information collecting unit and collects observation information of the main agent and the surrounding agent at the first time point by the second information collecting unit in step S110. The observation information may be shared and collected by communication with a main agent or a surrounding agent and the behavior information may be collected by observing the behavior of the surrounding agent by the main agent.

Further, the decision-making apparatus determines a character coefficient of the surrounding agent using the maximum likelihood method based on the observation information of the surrounding agent in step S120 and predicts a behavior of the surrounding agent based on the observation information of the main agent and the surrounding agent at the first time point and the character coefficient of the surrounding agent in step S130.

At this time, the step of predicting a behavior of the surrounding agent includes a step of predicting a behavior of the surrounding agent using observation information of the surrounding agent excluding observation information of the main agent collected by the second information collecting unit.

Further, the decision-making apparatus infers expected observation information of the main agent including the surrounding agent and the environment at the second time point corresponding to the behavior prediction result of the surrounding agent in step S140 and determines a behavior of the main agent at the first time point based on the expected observation information of the main agent including the surrounding agent and the environment at the second time point in step S150.

As described above, the decision-making apparatus and method according to the present disclosure may determine a behavior of a main agent with a high reward by considering future environment information by predicting a behavior of a surrounding agent.

Further, the decision-making apparatus and method according to the present disclosure may accurately infer a feature of the surrounding agent using the maximum likelihood method and the gradient descent method.

As described above, although the present disclosure has been described with reference to the exemplary drawings, it is obvious that the present disclosure is not limited by the exemplary embodiment and the drawings disclosed in the present disclosure and various modifications may be performed by those skilled in the art within the range of the technical spirit of the present disclosure. Further, although the effects of the configuration of the present disclosure have not been explicitly described while describing the embodiments of the present disclosure, it is natural that the effects predictable by the configuration should also be recognized.

What is claimed is:

1. A decision-making method, comprising:
collecting observation information and behavior information of a surrounding agent, by a first information collecting unit;
determining a character coefficient of the surrounding agent using the maximum likelihood method based on the observation information of the surrounding agent, by a character inferring unit;
collecting observation information of a main agent and the surrounding agent at a first time point, by a second information collecting unit;
predicting a behavior of the surrounding agent based on the observation information of the main agent and the surrounding agent at the first time point and the character coefficient of the surrounding agent, by a behavior predicting unit;
inferring expected observation information of the main agent including the surrounding agent and the environment at a second time point corresponding to the behavior prediction result of the surrounding agent, by a state inferring unit; and
deciding a behavior of the main agent at the first time point based on the expected observation information of the main agent including the surrounding agent and the environment at the second time point, by a decision-making unit.

2. The decision-making method according to claim 1, wherein the determining of a character coefficient of the surrounding agent includes:
randomly initializing an estimated character coefficient of the surrounding agent;
sampling a behavior of the surrounding agent using the estimated character coefficient, the observation information, and a multi-character reinforcement learning model; and
determining the character coefficient of the surrounding agent by comparing the sampled behavior and the behavior information.

3. The decision-making method according to claim 1, wherein the estimated character coefficient of the surrounding agent is updated by the following Equation 1.
$$\\ \begin{matrix}{\hat{c}}_{k + 1} = arg {max}_{c} {\sum }_{t = 1}^{T} [ - ( \frac{1}{2} ln 2 π {σ}_{π}^{2} + \frac{{a}_{acc , t} - {a}_{acc , t}^{*}}{2 π {σ}_{π}^{2}} ) + ( {a}_{lc , t} - {a}_{lc , t}^{*} ) ] & [ Equation 1 ]\end{matrix}$$
Here, ĉₖ₊₁ is an updated estimated character coefficient of the surrounding agent, a_{acc,t} and a_{lc,t} are sampled behaviors of the surrounding agent, and a_{acc,t}* and a_{lc,t}* are (actual) behavior information of the surrounding agent, respectively.

4. The decision-making method according to claim 1, wherein in the predicting of a behavior of the surrounding agent, the behavior of the surrounding agent is predicted using observation information of the surrounding agent excluding the observation information of the main agent, among observation information collected by the second information collecting unit.

5. A decision-making apparatus, comprising:
one or more processors which execute an instruction,
wherein the one or more processors perform:
collecting observation information and behavior information of a surrounding agent, by a first information collecting unit;
determining a character coefficient of the surrounding agent using the maximum likelihood method based on the observation information of the surrounding agent, by a character inferring unit;
collecting observation information of a main agent and the surrounding agent at a first time point, by a second information collecting unit;
predicting a behavior of the surrounding agent based on the observation information of the main agent and the surrounding agent at the first time point and the character coefficient of the surrounding agent, by a behavior predicting unit;
inferring expected observation information of the main agent including the surrounding agent and the environment at a second time point corresponding to the behavior prediction result of the surrounding agent, by a state inferring unit; and
deciding a behavior of the main agent at the first time point based on the expected observation information of the main agent including the surrounding agent and the environment at the second time point, by a decision-making unit.

6. The decision-making apparatus according to claim 5, wherein the character inferring unit randomly initializes an estimated character coefficient of the surrounding agent, samples a behavior of the surrounding agent using the estimated character coefficient, the observation information, and a multi-character reinforcement learning model, and determines the character coefficient of the surrounding agent by comparing the sampled behavior and the behavior information.

7. The decision-making apparatus according to claim 5, wherein the estimated character coefficient of the surrounding agent is updated by the following Equation 1.
$$\\ \begin{matrix}{\hat{c}}_{k + 1} = arg {max}_{c} {\sum }_{t = 1}^{T} [ - ( \frac{1}{2} ln 2 π {σ}_{π}^{2} + \frac{{a}_{acc , t} - {a}_{acc , t}^{*}}{2 π {σ}_{π}^{2}} ) + ( {a}_{lc , t} - {a}_{lc , t}^{*} ) ] & [ Equation 1 ]\end{matrix}$$
Here, ĉₖ₊₁ is an updated estimated character coefficient of the surrounding agent, a_{acc,t} and a_{lc,t} are sampled behaviors of the surrounding agent, and a_{acc,t}* and a_{lc,t}* are (actual) behavior information of the surrounding agent, respectively.

8. The decision-making apparatus according to claim 5, wherein the behavior predicting unit predicts the behavior of the surrounding agent using observation information of the surrounding agent excluding the observation information of the main agent, among observation information collected by the second information collecting unit.
